(19) United States
(12) Patent Application Publication
(10) Pub. No.: US 2021/0097644 A1
(43) Pub. Date: Apr. 1, 2021

(54) GAZE ADJUSTMENT AND ENHANCEMENT FOR EYE IMAGES

(71) Applicant: Microsoft Technology Licensing, LLC, Redmond, WA (US)

(72) Inventors: Eric Chris Wolfgang SOMMERLADE, Oxford (GB); Alexandros NEOFYTOU, London (GB); Sunando SENGUPTA, Reading (GB)

(73) Assignee: Microsoft Technology Licensing, LLC, Redmond, WA (US)

(21) Appl. No.: 16/696,639

(22) Filed: Nov. 26, 2019

Related U.S. Application Data
(60) Provisional application No. 62/908,363, filed on Sep. 30, 2019.

(51) Int. Cl. G06T 3/20; G06T 5/00; G06T 7/00; G06K 9/00

(52) U.S. Cl. CPC G06T 3/20; G06T 5/005; G06T 7/0002; G06K 9/00228; G06T 2207/10016; G06T 2207/30201; G06T 2207/20081; G06T 2207/20084; G06T 2207/30168; G06K 9/00597

(57) ABSTRACT

A method for image enhancement on a computing device includes receiving a digital input image depicting a human eye. From the digital input image, the computing device generates a gaze-adjusted image via a gaze adjustment machine learning model by changing an apparent gaze direction of the human eye. From the gaze-adjusted image and potentially in conjunction with the digital input image, the computing device generates a detail-enhanced image via a detail enhancement machine learning model by adding or modifying details. The computing device outputs the detail-enhanced image.

### CROSS REFERENCE TO RELATED APPLICATIONS

This application claims priority to U.S. Provisional Patent Application Ser. No. 62/908,363, filed Sep. 30, 2019, the entirety of which is hereby incorporated herein by reference for all purposes.

### BACKGROUND

Computing devices may be used to enable real-time communication between two or more users over a network. When any or all of the computing devices include a suitable integrated or external camera, the real-time communication may include live video of the two or more users.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A method for image enhancement on a computing device includes receiving a digital input image depicting a human eye. From the digital input image, the computing device generates a gaze-adjusted image via a gaze adjustment machine learning model by changing an apparent gaze direction of the human eye. From the gaze-adjusted image and potentially in conjunction with the digital test image, the computing device generates a detail-enhanced image via a detail enhancement machine learning model by adding or modifying details. The computing device outputs the detail-enhanced image.

### BRIEF DESCRIPTION OF THE DRAWINGS

FIG. 1 schematically illustrates gaze adjustment and detail enhancement for a digital input image depicting a human eye.

FIG. 2 schematically illustrates training of a gaze adjustment machine learning model.

FIG. 3 schematically illustrates training of a detail enhancement machine learning model.

FIG. 4 depicts example computer generated images usable for training of a detail enhancement machine learning model.

FIG. 5 schematically shows an example computing system.

### DETAILED DESCRIPTION

Computing devices can capture images of a human user via a suitable external or integrated camera (e.g., webcam, forward facing smartphone camera). Such images may be, for example, saved for later viewing, or transmitted over a network for display by a different computing device (e.g., as part of a one-way video stream or multi-way communication with one or more different users). During video capture, it is common for users not to look directly into the camera, instead focusing on their display or something else in their environment. Thus, the user will often not appear to be making direct eye contact with any viewers of the video, which can be disconcerting and interfere with effective communication.

Accordingly, the present disclosure is directed to techniques for gaze adjustment and detail enhancement for images of human eyes. Via these techniques, images of the eyes may be modified to change the apparent gaze direction of the user—for instance, such that it appears the user is looking directly into the camera. Gaze adjustment and detail enhancement may be applied in a manner that preserves high frequency details and avoids a “regression-to-mean” effect, while preserving individual eye shapes after transformation and maintaining realistic aspects of the input image, such as the color balance and noise levels. In some cases, the herein described gaze adjustment may limit invention of new pixels and preserve pixel color and intensity distributions. Furthermore, the herein described gaze adjustment may be a lightweight and fast process that is independent of camera position and image resolution.

Previous attempts at gaze adjustment have obfuscated and/or eliminated details of the eyes' appearance, such as the user's eyelashes; glints/reflections/specular highlights in the sclera, pupil, and iris; and wetness around the eye corners (i.e., canthi). Accordingly, detail enhancement may be applied to gaze-adjusted images of eyes to restore or replace details removed by the gaze adjustment process. In this manner, users may communicate more effectively and naturally via digital video without needing to uncomfortably or unnaturally stare into a camera for the duration of the video capture.

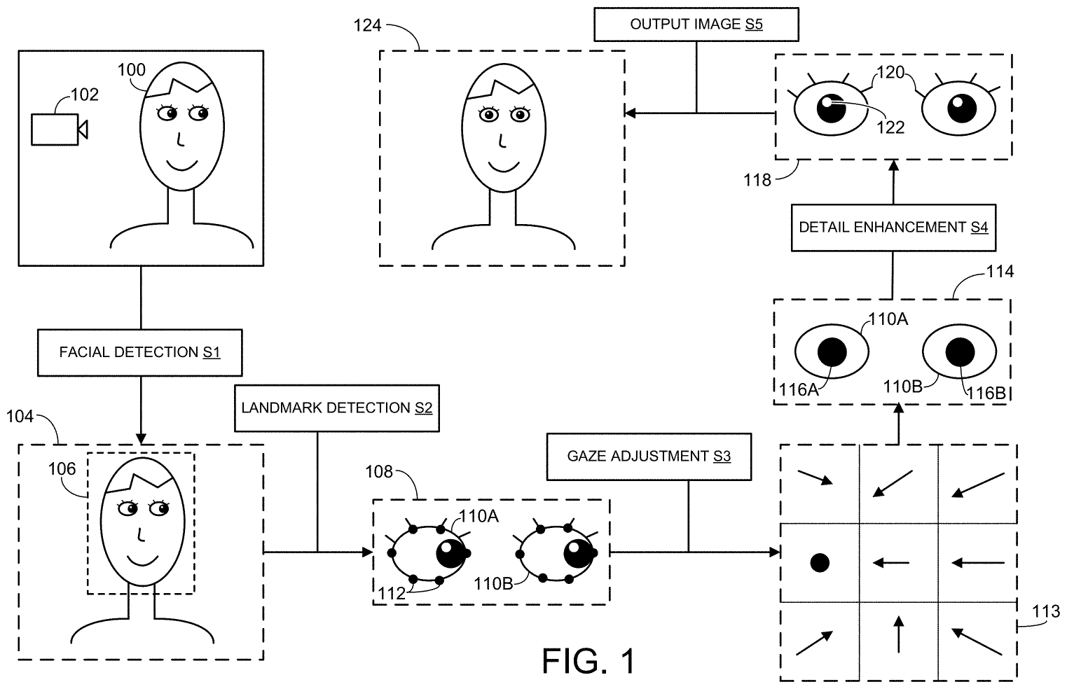

FIG. 1 schematically illustrates an example process for gaze adjustment and detail enhancement for images including human eyes. This and similar processes may be implemented in any scenario in which one or more digital images of a human are captured. The present disclosure primarily focuses on a scenario in which live video of a user is captured. In other words, the digital input image to which gaze adjustment and detail enhancement are applied may be one frame of a video stream including a plurality of frames. It will be understood, however, that this need not be the case. Rather, gaze adjustment and detail enhancement may be applied to image frames regardless of whether such frames are captured as part of a video sequence or individually (e.g., as digital photographs).

Furthermore, the present disclosure focuses primarily on modifying images depicting human eyes. However, similar modifications and enhancements may be applied to other features of a user's face/body, animals, inanimate objects, computer-generated characters/models, or any other image subject. For instance, similar image modification techniques may be used to change the size of a user's nose, change the appearance of the user's lips, eliminate blemishes on the user's face, change the apparent focal length of the camera (e.g., to provide the effect of a fisheye or wide field of view lens), alter the user's general facial appearance/expression, or change features in the user's environment. Furthermore, it will be understood that any or all of such image modifications may be applied to more than one user detected in the same image/video, and not just to a single individual.

FIG. 1 schematically depicts an example user 100 and a camera 102 capturing video of the user. As indicated above, gaze adjustment and detail enhancement may be performed by a computing device communicatively coupled with the camera. The camera may be separate from the computing device and communicate with the computing device over a suitable wired or wireless connection. Alternatively, the camera may be an integral component of the computing device—e.g., a forward-facing smartphone camera—or the camera itself may include computing components configured to perform gaze adjustment and detail enhancement as described herein. Regardless, the computing device may receive a digital input image depicting a human eye and perform gaze adjustment and detail enhancement on the digital input image.

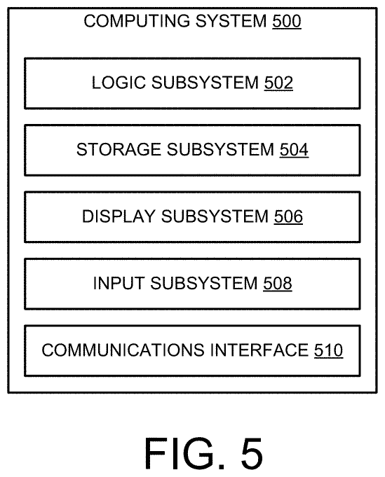

In some examples, gaze correction and detail enhancement may be performed by a different computing device than the one that receives images of the human user from the camera. For instance, a computing device communicatively coupled with camera 102 may transmit one or more images captured by camera 102 to a second computing device over a network. The first computing device may calculate a set of image modification instructions to be performed by the second computing device and include such instructions with the transmitted images. Additionally, or alternatively, the second computing device may perform gaze adjustment and detail enhancement independently of the first computing device. Regardless, the computing device that implements the herein-described techniques will receive a digital input image, either from a camera, another computing device, or another suitable source. The computing device may have any suitable hardware configuration and form factor and may in some examples be implemented as the computing system described below with respect to FIG. 5.

Furthermore, camera 102 may be any camera suitable for capturing digital images of a human user, and may include any suitable optics, image sensors, and processing logic. The camera may be sensitive to any spectra of light, including visible light, infrared, ultraviolet, etc. In some cases, the camera may be one of an array of cameras, each configured to capture images/videos of a human user. Images captured by the camera may have any suitable resolution. In cases where the camera captures video, individual frames of the video may be captured with any suitable frame rate.

At S1, the computing device optionally performs facial detection to detect a human face 106 of user 100 in a digital input image 104 captured by camera 102. The user's face may be detected in any suitable way using any suitable facial detection models or techniques. In some cases, facial detection may be performed using suitable machine learning approaches, as will be described below with respect to FIG. 5 (e.g., previously-trained, machine learning, facial detection classifiers). Often, facial detection will detect a region of pixels in a digital image that are determined to correspond to a human face, in some cases with a corresponding confidence value. In some implementations, an eye box, or even a left eye box and a right eye box, around a user's eyes additionally or alternatively may be detected.

Once the digital input image is received, the computing device may perform gaze adjustment to generate a gaze-adjusted image by changing an apparent gaze direction of the human eye. In one example process, this may include, at S2, identifying a plurality of landmarks in the digital input image. In implementations where a face and/or one or more eye boxes have been identified, this type of landmarking may be focused only on those previously-identified portions of the image known to include the eyes. Specifically, FIG. 1 includes a digital input image 108 depicting human eyes 110A and 110B, with a plurality of identified landmarks 112. Such landmarks may be identified in any suitable way and may correspond to predefined landmarks, anchors, or keypoints in a facial alignment library. The specific arrangement of landmarks shown in FIG. 1 is only an example and is not limiting. Furthermore, in FIG. 1, landmarks are identified for both eyes 110A and 110B. However, in some cases, landmarks may only be identified for one of a user's eyes, and any modifications applied to one eye may be mirrored and applied to the other eye as well.

At S3, the computing device performs gaze adjustment to change the apparent gaze direction of the human eyes. In some examples, this may be done via a machine learning trained neural network configured to generate a two-dimensional displacement vector field. An example two-dimensional displacement vector field 113 is shown in FIG. 1, which identifies, for each of one or more pixels in the digital input image, a displacement vector for the pixel. A gaze-adjusted image may then be generated by displacing the one or more pixels in the digital input image according to the two-dimensional displacement vector field. In this schematic representation, vectors are only depicted for nine pixels; but it should be understood that similar vectors may be calculated for every pixel in input image 108. For each location in the two-dimensional displacement vector field, a relative position may be defined that is used to look up the desired value for each output pixel. Details regarding suitable machine learning approaches and techniques will be described in more detail below with respect to FIG. 5.

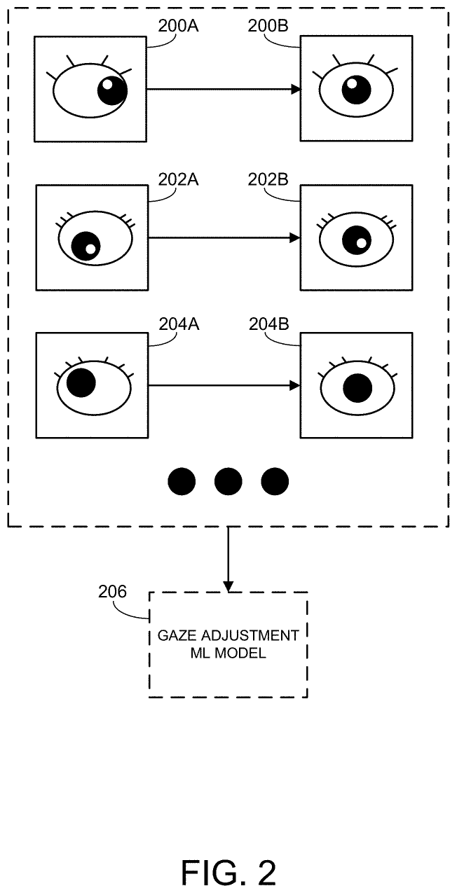

An example process for training a gaze adjustment machine learning model is schematically illustrated in FIG. 2. Specifically, a computing device may be provided with a set of original training images 200A, 202A, and 204A, respectively paired with a set of corresponding gaze-adjusted target images 200B, 202B, and 204B. These images may be real images captured of real human subjects. For instance, the original training images may be captured while the human subjects are looking away from the camera, while the gaze-adjusted target images are captured while the human subjects are looking into the camera, or in another direction that differs from the original images. Alternatively, either or both of the original images and target images may be synthetically generated, as will be described in more detail below. Regardless, pairs including original and target images may be used as the basis for training a gaze adjustment machine learning model 206, which may then apply gaze adjustment to new input images as is illustrated in FIG. 1. For example, the gaze adjustment machine learning model may be trained to generate two-dimensional displacement vector fields for the original training images that reduce differences between the original training images and gaze-adjusted target images. Once trained in this manner, the gaze adjustment machine learning model may be used to generate additional two-dimensional displacement vector fields for novel digital input images. While FIG. 2 only shows three pairs of training original/target images, it should be understood that many more pairs will typically be used to train the model.

Furthermore, in FIG. 2, only single eyes are shown in the original and target images. As discussed above, gaze adjustment and detail enhancement may in some cases be applied to one of a user's eyes, and the applied changes may be mirrored and applied to the user's other eye. In other examples, however, gaze adjustment and detail enhancement may be applied to each of the user's eyes independently. In some cases, the same gaze adjustment machine learning model may be applied to both eyes, or two different gaze adjustment machine learning models may be separately trained and applied to left and right eyes.

The present disclosure primarily describes applying gaze adjustment such that a user appears to be looking directly into a camera that is positioned in front of the user's face. Thus, the positions of the user's pupils may be changed such that the pupils are in the approximate centers of the user's eyes, as is shown in target images 200B, 202B, and 204B. However, gaze adjustment may be applied such that the user appears to be looking in any arbitrary direction. As such, target images used for training a machine learning model may include images in which the user's pupils are offset from center, unlike those shown in FIG. 2.

Returning to FIG. 1, the computing device uses a gaze adjustment machine learning model to generate two-dimensional displacement vector field 113, which is applied to the input image 108. This results in a gaze-adjusted image 114, in which pixels corresponding to the positions of the pupils 116A and 116B of eyes 110A and 110B are shifted to the approximate centers of the eyes. In this example, only the positions of the eye pupils are changed during gaze adjustment, although other features of the eyes may also be changed, such as the user's eyelids. In general, performing gaze adjustment may involve modifying the digital input image in any suitable way, including shifting or copying the positions of individual pixels or pixel regions, applying a smudge filter, pixel noise generator, and adjusting the brightness, saturation, and/or hue of individual pixels or pixel regions.

In some cases, after the gaze-adjusted image is generated, the computing device may be configured to apply a discriminator function to evaluate a realism of the gaze-adjusted image. For instance, the gaze adjustment machine learning model may include or be supplemented by a generative adversarial network (GAN) comprising a discriminator function and a generator function. The discriminator function allows for disambiguating realistic images of eye regions from erroneous or synthetic ones. The generator function provides novel output based on the digital input image. The GAN discriminator may be used to judge the quality of gaze-adjusted images output by the gaze adjustment machine learning model. For instance, the GAN discriminator may output a binary result—e.g., a 0 or a 1—based on whether a gaze-adjusted image resembles a real eye, and this can serve as positive or negative feedback for modifying or refining the gaze adjustment machine learning model. For instance, based on feedback from the GAN discriminator, the weightings or gradients applied to digital input images by the gaze adjustment machine learning model may be adjusted, such that the model is progressively trained to produce more consistently realistic results. In other cases, the GAN discriminator may provide another suitable output, such as a confidence value that the gaze-adjusted image includes a real human eye. As with the gaze adjustment machine learning model, the GAN may be trained in any suitable way and utilize any suitable machine learning or artificial intelligence technologies, including those described below with respect to FIG. 5.

As discussed above, gaze adjustment can sometimes result in a loss in detail of the image of the human eyes. While use of a GAN discriminator can help to alleviate this problem, some loss in detail may still occur in some scenarios. In FIG. 1, the gaze-adjusted image of eyes 110A and 110B has reduced detail as compared to the pre-adjustment images. Specifically, the eyes no longer have eyelashes or a specular glint. This can in some cases be disconcerting for viewers of the gaze-adjusted image and can interfere with effective communication.

Accordingly, at S4, the computing device generates a detail-enhanced image from a gaze-adjusted image via a detail enhancement machine learning model. Notably, the gaze adjustment machine learning model outputs the gaze-adjusted image in a format supported by the detail enhancement machine learning model—e.g., a format having a particular number of pixels, aspect ratio, color channels, filetype, codec, compression protocol, metadata, wrapper, and/or other attributes that the detail enhancement machine learning model is configured to process. In some cases, the gaze-adjusted image may be provided to the detail enhancement machine learning model via a supported API, and gaze adjustment and detail enhancement may optionally be performed by separate computing devices.

In this case, detail enhancement is a separate process that is applied after gaze adjustment—e.g., as a post processing step. In other examples, however, detail enhancement may be performed at the same time as gaze adjustment (e.g., via a convolutional neural network trained for gaze adjustment and detail enhancement). Regardless, however, the computing device may apply a detail enhancement machine learning model to an image depicting a human eye to add, supplement, or replace details of the image, including eyelashes and specular highlights in the sclera, pupil, iris, and canthi. As with the gaze adjustment machine learning model, the detail enhancement machine learning model may utilize any suitable machine learning or artificial intelligence techniques or approaches, including those described below with respect to FIG. 5. Furthermore, the detail enhancement machine learning model may be trained in any suitable way.

Detail enhancement is generally described herein in the context of replacing details of an image depicting a human eye that were lost during either or both of data capture and gaze adjustment. However, it will be understood that detail enhancement may be applied independently of gaze adjustment and may be used in any cases where digital images exhibit a loss in detail. For instance, detail enhancement may be applied to images exhibiting compression artifacts or motion blur, regardless of whether gaze adjustment is also applied to such images.

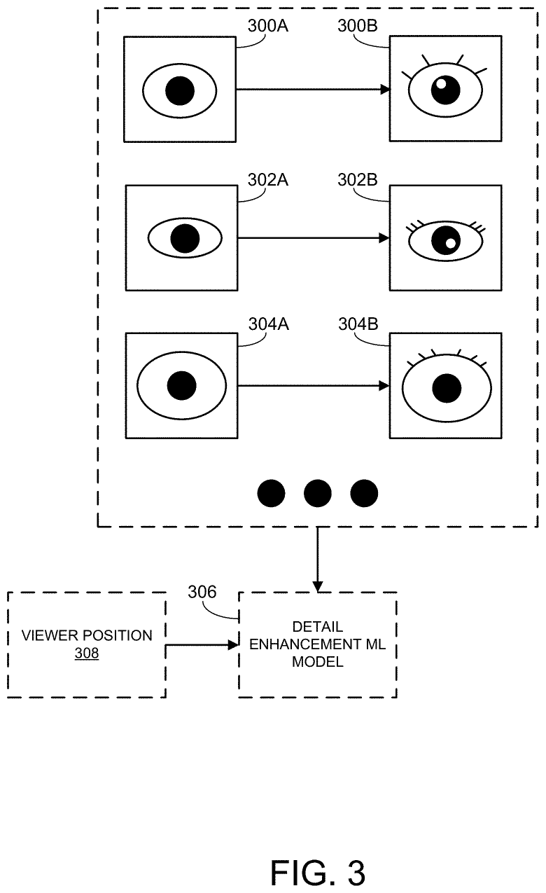

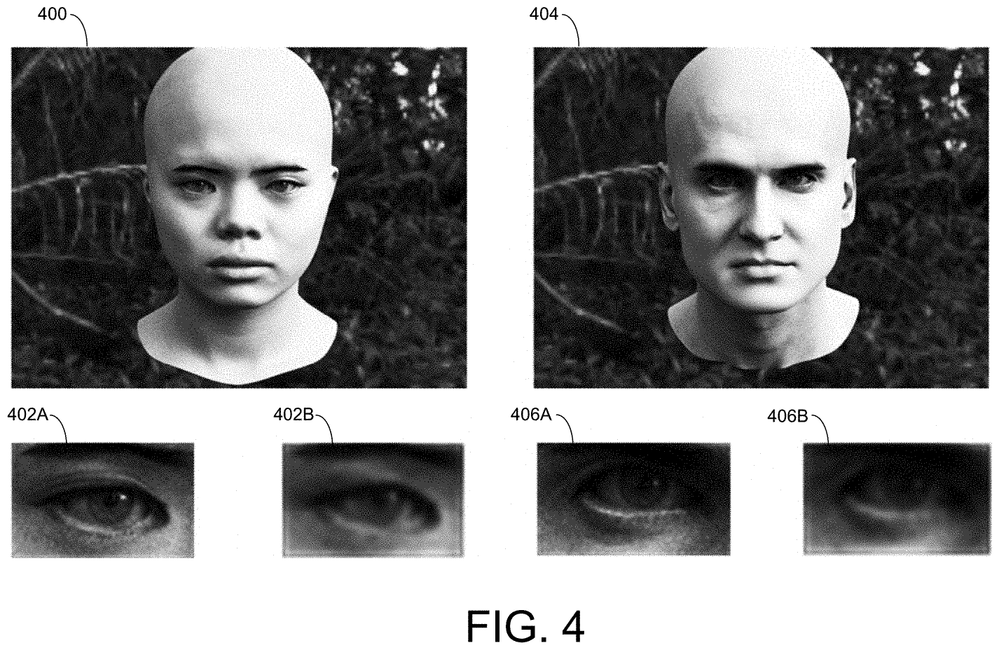

FIG. 3 schematically illustrates one example approach for training a detail enhancement machine learning model. Specifically, a computing device may be provided with a set of original training images 300A, 302A, and 304A, respectively paired with a set of corresponding detail-enhanced target images 300B, 302B, and 304B. These images may be real images captured of real human subjects. For instance, the detail-enhanced target images may be unmodified images of a real human's eyes, while the original training images are gaze-adjusted images, or are otherwise digitally modified to remove details in a manner that is consistent with gaze adjustment. Alternatively, either or both of the original training images and target images may be computer-generated, as will be described in more detail below with respect to FIG. 4. Regardless, such images may be used as the basis for training a detail enhancement machine learning model 306, which may then apply detail enhancement to new digital input images, or gaze-adjusted images, as is illustrated in FIG. 1. While FIG. 3 only shows three pairs of training original/target images, it should be understood that many more pairs will typically be used to train the model.

Once again, in FIG. 3, only single eyes are shown in the original and target images. As discussed above, gaze adjustment and detail enhancement may in some cases be applied to one of a user's eyes, and the applied changes may be mirrored and applied to the user's other eye. In other examples, however, gaze adjustment and detail enhancement may be applied to each of the user's eyes independently. In some cases, the same detail enhancement machine learning model may be applied to both eyes, or two different detail enhancement machine learning models may be separately trained and applied to left and right eyes.

In some cases, an output of the above described gaze adjustment and/or detail enhancement techniques may be tuned for the configuration of a display system used to display the resulting enhanced images. In particular, for head mounted stereoscopic views or multi-view displays, adding synthetic glints/imagery may depend on the assumed position of the viewer of the enhanced image, and thus multiple possible enhanced images may be generated for different possible viewpoints. Furthermore, the viewer position may optionally be used as an input for training the detail enhancement machine learning model. This is shown in FIG. 3, as viewer position 308 is provided to model 306. In this manner, the model may be trained to output realistically enhanced images for a range of possible viewer positions.

As with gaze adjustment, applying detail enhancement to an image may include performing any suitable image modifications. As one example, generating a detail-enhanced image may include supplementing or replacing eyelashes in an image of a human eye, as eyelash detail is often lost during gaze adjustment. In some cases, details from the digital input image may be added to the gaze-adjusted image, such as pixels depicting eyelashes. Additionally, or alternatively, generating a detail-enhanced image may include adding simulated glints to a surface of the eye. This may in some cases be done based on inferred lighting characteristics of an environment depicted in the digital input image, as will be described in more detail below.

In general, however, any suitable image modifications may be made during detail enhancement. For example, pixels may be moved, copied, replaced, or added, the hue/brightness/saturation of pixels may be changed, the resolution of the image may be increased or decreased, compression/blur/pixel noise may be added or removed, or image regions from prior images of the user may be added (e.g., to add eyelashes from a prior image). Furthermore, the detail enhancement machine learning model may add artificial glare and highlights and generate synthetic imagery consistent with desired lighting conditions.

As discussed above, either or both of the gaze adjustment and detail enhancement machine learning models may be trained partially or entirely with computer-generated training images. Examples of such images are shown in FIG. 4, which includes two computer-generated training images 400 and 404. These images include synthetic models of human faces with simulated lighting effects against a synthetic background. FIG. 4 also includes images 402A and 406A, which depict individual eyes from the synthetic models in relatively high resolution. By contrast, images 402B and 406B are relatively lower resolution versions of images 402A and 406A.

When computer-generated training images are used, the machine learning models may be trained on a range of different lighting conditions, head shapes/geometries, positions, skin/eye reflectance properties, image resolutions, and backgrounds, which can improve the accuracy with which the trained models enhance new images. For instance, by providing computer-generated training images under different synthetic lighting conditions, the computing device may more realistically apply glints or reflections to new images of user eyes during detail enhancement—e.g., by examining an input image to determine the general lighting characteristics of the user's environment, and adding glints/reflections consistent with the inferred lighting conditions. In other words, the models may be trained to consider assessed lighting conditions or other environmental factors.

Returning to FIG. 1, after the computing device performs detail enhancement at S4, the computing device generates a detail-enhanced image 118. As shown, the image of the human eyes now includes eyelashes 120 and specular glints 122. At S5, the computing device outputs an enhanced image 124 of user 100, which incorporates detail-enhanced image 118 (e.g., via any suitable image combination approach). The user's gaze has been adjusted, and eye details are enhanced in the enhanced image 124. As indicated above, the gaze adjustment and detail enhancement processes described herein need not be performed by a computing device that receives captured images directly from a camera, or displays target images on a computer display. Thus, outputting the image at S5 may include displaying the image, combining the image with one or more other images, transmitting the enhanced image over a network (e.g., for display by a second device), or saving the enhanced image for later viewing. Furthermore, the initial input image may in some cases be received from a computing device along with a set of modification instructions that, when applied, achieve the gaze adjustment and detail enhancement effects described above.

The methods and processes described herein may be tied to a computing system of one or more computing devices. In particular, such methods and processes may be implemented as an executable computer-application program, a network-accessible computing service, an application-programming interface (API), a library, or a combination of the above and/or other compute resources.

FIG. 5 schematically shows a simplified representation of a computing system 500 configured to provide any to all of the compute functionality described herein. Computing system 500 may take the form of one or more personal computers, network-accessible server computers, tablet computers, home-entertainment computers, gaming devices, mobile computing devices, mobile communication devices (e.g., smart phone), virtual/augmented/mixed reality computing devices, wearable computing devices, Internet of Things (IoT) devices, embedded computing devices, and/or other computing devices.

Computing system 500 includes a logic subsystem 502 and a storage subsystem 504. Computing system 500 may optionally include a display subsystem 506, input subsystem 508, communication subsystem 510, and/or other subsystems not shown in FIG. 5.

Logic subsystem 502 includes one or more physical devices configured to execute instructions. For example, the logic subsystem may be configured to execute instructions that are part of one or more applications, services, or other logical constructs. The logic subsystem may include one or more hardware processors configured to execute software instructions. Additionally, or alternatively, the logic subsystem may include one or more hardware or firmware devices configured to execute hardware or firmware instructions. Processors of the logic subsystem may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely-accessible, networked computing devices configured in a cloud-computing configuration.

Storage subsystem 504 includes one or more physical devices configured to temporarily and/or permanently hold computer information such as data and instructions executable by the logic subsystem. When the storage subsystem includes two or more devices, the devices may be collocated and/or remotely located. Storage subsystem 504 may include volatile, nonvolatile, dynamic, static, read/write, read-only, random-access, sequential-access, location-addressable, file-addressable, and/or content-addressable devices. Storage subsystem 504 may include removable and/or built-in devices. When the logic subsystem executes instructions, the state of storage subsystem 504 may be transformed—e.g., to hold different data.

Aspects of logic subsystem 502 and storage subsystem 504 may be integrated together into one or more hardware-logic components. Such hardware-logic components may include program- and application-specific integrated circuits (PASIC/ASICs), program- and application-specific standard products (PSSP/ASSPs), system-on-a-chip (SOC), and complex programmable logic devices (CPLDs), for example.

The logic subsystem and the storage subsystem may cooperate to instantiate one or more logic machines. As used herein, the term “machine” is used to collectively refer to the combination of hardware, firmware, software, instructions, and/or any other components cooperating to provide computer functionality. In other words, “machines” are never abstract ideas and always have a tangible form. A machine may be instantiated by a single computing device, or a machine may include two or more sub-components instantiated by two or more different computing devices. In some implementations a machine includes a local component (e.g., software application executed by a computer processor) cooperating with a remote component (e.g., cloud computing service provided by a network of server computers). The software and/or other instructions that give a particular machine its functionality may optionally be saved as one or more unexecuted modules on one or more suitable storage devices.

Machines may be implemented using any suitable combination of state-of-the-art and/or future machine learning (ML), artificial intelligence (AI), and/or natural language processing (NLP) techniques. As discussed above, gaze-adjustment and/or detail-enhancement of digital input images may in some cases be performed via suitable ML and/or AI techniques. For example, a gaze adjustment machine learning model may be trained based on a plurality of paired original and target training images, where the original training images depict a real or virtual human subject gazing in a first direction, and the target training images depict the same real or virtual human subject gazing in a target direction (e.g., straight ahead). Similarly, a detail enhancement machine learning model may be trained based on a plurality of paired original and target training images, where the target training images depict human eyes having enhanced details (e.g., specular glints, enhanced eyelashes) relative to the original training images.

Non-limiting examples of techniques that may be incorporated in an implementation of one or more machines, and/or used to train either or both of a gaze adjustment machine learning model and a detail enhancement machine learning model, include support vector machines, multi-layer neural networks, convolutional neural networks (e.g., including spatial convolutional networks for processing images and/or videos, temporal convolutional neural networks for processing audio signals and/or natural language sentences, and/or any other suitable convolutional neural networks configured to convolve and pool features across one or more temporal and/or spatial dimensions), recurrent neural networks (e.g., long short-term memory networks), associative memories (e.g., lookup tables, hash tables, Bloom Filters, Neural Turing Machine and/or Neural Random Access Memory), word embedding models (e.g., GloVe or Word2Vec), unsupervised spatial and/or clustering methods (e.g., nearest neighbor algorithms, topological data analysis, and/or k-means clustering), graphical models (e.g., (hidden) Markov models, Markov random fields, (hidden) conditional random fields, and/or AI knowledge bases), and/or natural language processing techniques (e.g., tokenization, stemming, constituency and/or dependency parsing, and/or intent recognition, segmental models, and/or super-segmental models (e.g., hidden dynamic models)).

In some examples, the methods described herein may be implemented using one or more differentiable functions, wherein a gradient of the differentiable functions may be calculated and/or estimated with regard to inputs and/or outputs of the differentiable functions (e.g., with regard to training data, and/or with regard to an objective function). Such methods and processes may be at least partially determined by a set of trainable parameters. Accordingly, the trainable parameters for a particular method or process may be adjusted through any suitable training procedure, in order to continually improve functioning of the method or process.

Non-limiting examples of training procedures for adjusting trainable parameters include supervised training (e.g., using gradient descent or any other suitable optimization method), zero-shot, few-shot, unsupervised learning methods (e.g., classification based on classes derived from unsupervised clustering methods), reinforcement learning (e.g., deep Q learning based on feedback) and/or generative adversarial neural network training methods, belief propagation, RANSAC (random sample consensus), contextual bandit methods, maximum likelihood methods, and/or expectation maximization. In some examples, a plurality of methods, processes, and/or components of systems described herein may be trained simultaneously with regard to an objective function measuring performance of collective functioning of the plurality of components (e.g., with regard to reinforcement feedback and/or with regard to labelled training data). Simultaneously training the plurality of methods, processes, and/or components may improve such collective functioning. In some examples, one or more methods, processes, and/or components may be trained independently of other components (e.g., offline training on historical data).

When included, display subsystem 506 may be used to present a visual representation of data held by storage subsystem 504. This visual representation may take the form of a graphical user interface (GUI). Display subsystem 506 may include one or more display devices utilizing virtually any type of technology. In some implementations, display subsystem may include one or more virtual-, augmented-, or mixed reality displays.

When included, input subsystem 508 may comprise or interface with one or more input devices. An input device may include a sensor device or a user input device. Examples of user input devices include a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition.

When included, communication subsystem 510 may be configured to communicatively couple computing system 500 with one or more other computing devices. Communication subsystem 510 may include wired and/or wireless communication devices compatible with one or more different communication protocols. The communication subsystem may be configured for communication via personal-, local- and/or wide-area networks.

This disclosure is presented by way of example and with reference to the associated drawing figures. Components, process steps, and other elements that may be substantially the same in one or more of the figures are identified coordinately and are described with minimal repetition. It will be noted, however, that elements identified coordinately may also differ to some degree. It will be further noted that some figures may be schematic and not drawn to scale. The various drawing scales, aspect ratios, and numbers of components shown in the figures may be purposely distorted to make certain features or relationships easier to see.

In an example, a method for image enhancement on a computing device comprises: receiving a digital input image depicting a human eye; generating a gaze-adjusted image from the digital input image by changing an apparent gaze direction of the human eye via a gaze adjustment machine learning model; generating a detail-enhanced image from the gaze-adjusted image by adding or modifying details via a detail enhancement machine learning model; and outputting the detail-enhanced image. In this example or any other example, generating the gaze-adjusted image includes identifying a plurality of landmarks in the digital input image. In this example or any other example, generating the gaze-adjusted image further includes, based on the plurality of landmarks, generating a two-dimensional displacement vector field indicating, for each of one or more pixels in the digital input image, a displacement vector for the pixel, and generating the gaze-adjusted image by displacing the one or more pixels in the digital input image according to the two-dimensional displacement vector field. In this example or any other example, the gaze adjustment machine learning model is trained to generate two-dimensional displacement vector fields for digital input images based on a set of original training images and a corresponding set of gaze-adjusted target images. In this example or any other example, the method further comprises, after generating the gaze-adjusted image, applying a discriminator function to evaluate a realism of the gaze-adjusted image, and modifying the gaze adjustment machine learning model based on feedback from the discriminator function. In this example or any other example, the discriminator function is implemented as part of a generative adversarial network (GAN). In this example or any other example, generating the detail-enhanced image includes adding details to compensate for details that were lost during either or both of data capture and gaze adjustment. In this example or any other example, generating the detail-enhanced image includes supplementing or adding pixels depicting eyelashes. In this example or any other example, generating the detail-enhanced image includes adding simulated glints to a surface of the eye based on inferred lighting characteristics of an environment depicted in the digital input image. In this example or any other example, the detail enhancement machine learning model is trained based on a set of original training images and a corresponding set of detail-enhanced target images. In this example or any other example, one or both of the set of original training images and the corresponding set of detail-enhanced training images are computer-generated. In this example or any other example, the method further comprises, prior to generating the gaze-adjusted image, performing facial detection to detect a human face in the digital input image, the human face including the human eye. In this example or any other example, the gaze adjustment machine learning model outputs the gaze-adjusted image in a format supported by the detail enhancement machine learning model. In this example or any other example, the digital input image is one frame of a video stream including a plurality of frames.

In an example, a computing device comprises: a logic machine; and a storage machine holding instructions executable by the logic machine to: receive a digital input image depicting a human eye; generate a gaze-adjusted image from the digital input image by changing an apparent gaze direction of the human eye via a gaze adjustment machine learning model; generate a detail-enhanced image from the gaze-adjusted image by adding or modifying details via a detail enhancement machine learning model; and output the detail-enhanced image. In this example or any other example, generating the gaze-adjusted image includes, based on a plurality of landmarks identified in the digital input image, generating a two-dimensional displacement vector field indicating, for each of one or more pixels in the digital input image, a displacement vector for the pixel, and generating the gaze-adjusted image by displacing the one or more pixels in the digital input image according to the two-dimensional displacement vector field. In this example or any other example, the instructions are further executable to, after generating the gaze-adjusted image, apply a discriminator function to evaluate a realism of the gaze-adjusted image, and modify the gaze adjustment machine learning model based on feedback from the discriminator function, where the discriminator function is implemented as part of a generative adversarial network (GAN). In this example or any other example, generating the detail-enhanced image includes adding details to compensate for details that were lost during either or both of data capture and gaze adjustment. In this example or any other example, generating the detail-enhanced image includes adding simulated glints to a surface of the eye based on inferred lighting characteristics of an environment depicted in the digital input image.

In an example, a method for image enhancement on a computing device comprises: receiving a digital input image depicting a human eye; via a gaze adjustment machine learning model, generating a two-dimensional displacement vector field indicating, for each of one or more pixels in the digital input image, a displacement vector for the pixel; generating a gaze-adjusted image from the digital input image by displacing the one or more pixels in the digital input image according to the two-dimensional displacement vector field to change an apparent gaze direction of the human eye; applying a discriminator function to evaluate a realism of the gaze-adjusted image; modifying the gaze adjustment machine learning model based on feedback from the discriminator function; generating a detail-enhanced image from the gaze-adjusted image by adding or modifying details via a detail enhancement machine learning model; and outputting the detail-enhanced image.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for image enhancement on a computing device, the method comprising:
receiving a digital input image depicting a human eye;
generating a gaze-adjusted image from the digital input image by changing an apparent gaze direction of the human eye via a gaze adjustment machine learning model;
generating a detail-enhanced image from the gaze-adjusted image by adding or modifying details via a detail enhancement machine learning model; and
outputting the detail-enhanced image.

2. The method of claim 1, where generating the gaze-adjusted image includes identifying a plurality of landmarks in the digital input image.

3. The method of claim 2, where generating the gaze-adjusted image further includes, based on the plurality of landmarks, generating a two-dimensional displacement vector field indicating, for each of one or more pixels in the digital input image, a displacement vector for the pixel, and generating the gaze-adjusted image by displacing the one or more pixels in the digital input image according to the two-dimensional displacement vector field.

4. The method of claim 3, where the gaze adjustment machine learning model is trained to generate two-dimensional displacement vector fields for digital input images based on a set of original training images and a corresponding set of gaze-adjusted target images.

5. The method of claim 1, further comprising, after generating the gaze-adjusted image, applying a discriminator function to evaluate a realism of the gaze-adjusted image, and modifying the gaze adjustment machine learning model based on feedback from the discriminator function.

6. The method of claim 5, where the discriminator function is implemented as part of a generative adversarial network (GAN).

7. The method of claim 1, where generating the detail-enhanced image includes adding details to compensate for details that were lost during either or both of data capture and gaze adjustment.

8. The method of claim 1, where generating the detail-enhanced image includes supplementing or adding pixels depicting eyelashes.

9. The method of claim 1, where generating the detail-enhanced image includes adding simulated glints to a surface of the eye based on inferred lighting characteristics of an environment depicted in the digital input image.

10. The method of claim 1, where the detail enhancement machine learning model is trained based on a set of original training images and a corresponding set of detail-enhanced target images.

11. The method of claim 1, where one or both of the set of original training images and the corresponding set of detail-enhanced training images are computer-generated.

12. The method of claim 1, further comprising, prior to generating the gaze-adjusted image, performing facial detection to detect a human face in the digital input image, the human face including the human eye.

13. The method of claim 1, where the gaze adjustment machine learning model outputs the gaze-adjusted image in a format supported by the detail enhancement machine learning model.

14. The method of claim 1, where the digital input image is one frame of a video stream including a plurality of frames.

15. A computing device, comprising:
a logic machine; and
a storage machine holding instructions executable by the logic machine to:
receive a digital input image depicting a human eye;
generate a gaze-adjusted image from the digital input image by changing an apparent gaze direction of the human eye via a gaze adjustment machine learning model;
generate a detail-enhanced image from the gaze-adjusted image by adding or modifying details via a detail enhancement machine learning model; and
output the detail-enhanced image.

16. The computing device of claim 15, where generating the gaze-adjusted image includes, based on a plurality of landmarks identified in the digital input image, generating a two-dimensional displacement vector field indicating, for each of one or more pixels in the digital input image, a displacement vector for the pixel, and generating the gaze-adjusted image by displacing the one or more pixels in the digital input image according to the two-dimensional displacement vector field.

17. The computing device of claim 15, where the instructions are further executable to, after generating the gaze-adjusted image, apply a discriminator function to evaluate a realism of the gaze-adjusted image, and modify the gaze adjustment machine learning model based on feedback from the discriminator function, where the discriminator function is implemented as part of a generative adversarial network (GAN).

18. The computing device of claim 15, where generating the detail-enhanced image includes adding details to compensate for details that were lost during either or both of data capture and gaze adjustment.

19. The computing device of claim 15, where generating the detail-enhanced image includes adding simulated glints to a surface of the eye based on inferred lighting characteristics of an environment depicted in the digital input image.

20. A method for image enhancement on a computing device, comprising:
receiving a digital input image depicting a human eye;
via a gaze adjustment machine learning model, generating a two-dimensional displacement vector field indicating, for each of one or more pixels in the digital input image, a displacement vector for the pixel;
generating a gaze-adjusted image from the digital input image by displacing the one or more pixels in the digital input image according to the two-dimensional displacement vector field to change an apparent gaze direction of the human eye;
applying a discriminator function to evaluate a realism of the gaze-adjusted image;
modifying the gaze adjustment machine learning model based on feedback from the discriminator function;
generating a detail-enhanced image from the gaze-adjusted image by adding or modifying details via a detail enhancement machine learning model; and
outputting the detail-enhanced image.
